(19) United States
(12) Patent Application Publication
(10) Pub. No.: US 2005/0078931 A1
(43) Pub. Date: Apr. 14, 2005

(54) Multi-channel variable optical attenuator and fabrication method thereof

(76) Inventors: Hyun Kee Lee, Suwon (KR); Yoon Shik Hong, Sungnam (KR); Sung Jun Lee, Seoul (KR)

Correspondence Address: LOWE HAUPTMAN GILMAN & BERNER, LLP;Suite 310, 1700 Diagonal Road, Alexandria, VA, 22314, US

(21) Appl. No.: 10/735,647

(22) Filed: Dec. 16, 2003

(30) Foreign Application Priority Data
Oct. 9, 2003 (KR) 2003-70414

(51) Int. Cl. G02B 6/26

(52) U.S. Cl. 385/140; 385/19

(57) ABSTRACT

The present invention relates to a multi-channel variable optical attenuator, more particularly, which comprises a multilayer structure of a fiber optic module and an attenuating module in order to enhance the integrity of the multi-channel variable optical attenuator. The multi-channel variable optical attenuator comprises at least two optical signal transmission lines which are arranged parallel with each other, and have associated separating spaces formed between input and output terminals to adjust the power of an optical signal. A screen is placed in one of the separating spaces of the optical signal transmission lines, and movable in a direction crossing the optical signal transmission lines. A Micro Electro Mechanical System (MEMS) actuator is placed above one of the optical signal transmission lines, and connected with the screen to shift the same. The MEMS actuator is placed above a first optical signal transmission line which is placed adjacent to a second optical signal transmission line for placing the screen therein.

### BACKGROUND OF THE INVENTION

1. Field of the Invention

The present invention relates to a multi-channel variable optical attenuator, more particularly, which comprises a multilayer structure of a fiber optic module and an attenuating module in order to enhance the integrity of the multi-channel variable optical attenuator.

2. Description of the Related Art

An optical attenuator is one of important optical communication devices, and induces a predetermined level of loss to an input optical signal and then transmits the attenuated optical signal to an output terminal. In an optical communication network, optical powers received in some parts of the network have different intensities according to system constitution since optical fibers have different transmission losses according to transmission distance, different numbers of optical fiber connectors are used, and different types of optical couplers are used in transmission lines.

The optical attenuator comprises a fiber optic module having input and output terminals and an attenuating module functioning to attenuate an optical signal. The optical attenuator may be classified into a fixed optical attenuator and a variable optical attenuator (hereinafter will be referred to as ‘VOA’) which variably attenuates the optical signal. The VOA is also divided into a single channel VOA and a multi-channel VOA based upon the number of input and output terminals.

FIG. 1 illustrates a single channel VOA of the prior art, and FIG. 2 is a sectional view taken along a line A-A′ in FIG. 1. Referring to FIGS. 1 and 2, an input optical fiber 2 is spaced from an output optical fiber 3 to a predetermined gap. A screen 6 is placed in a space formed between the input and output optical fibers 2 and 3. The screen 6 is moved by a driving unit 5 which is fixed by a fixing unit 4.

As the conventional single channel VOA receives an optical signal 1 through the input optical fiber 2, the driving unit 5 fixed to the fixing unit 4 is actuated to shift the screen 6. The screen 6 partially blocks the input optical signal to reduce the optical power thereof so that an attenuated optical signal 7 is outputted through the output optical fiber 3.

FIG. 3 illustrates a multi-channel VOA of the prior art, which is realized by arraying a plurality of VOA modules as shown in FIG. 3. The multi-channel VOA in FIG. 3 comprises an array of VOA modules 10 and 20 each having one channel. The each VOA module 10 or 20 has an input optical fiber 12, an output optical fiber 13 and a screen 16 placed between input and output terminals. A driving unit 15 for driving the screen 16 and a fixing unit 14 for fixing the driving unit 15 are arranged coplanar with the input optical fiber 12 and the output optical fiber 13.

The multi-channel VOA of the prior art has a drawback that the area of the VOA increases in proportion to the number of the channels. That is, the conventional multi-channel VOA has an array structure of driving units and optical fibers alternating with the driving units in such a fashion that a first driving unit placed beside a first optical fiber is also placed beside a second optical fiber. Therefore, the conventional structure can rarely reduce the size of the multi-channel VOA or enhance the integrity thereof. Further, the conventional structure may hardly raise the yield of VOA articles produced from a predetermined area of wafer, thereby lowering productivity.

### SUMMARY OF THE INVENTION

Accordingly, the present invention has been made to solve the foregoing problems and it is an object of the present invention to provide an optical attenuator comprising a fiber optic module and an attenuating module separated from the fiber optic module in which the attenuating module is arrayed on a plane different from that of the fiber optic module to reduce the overall area of the optical attenuator as well as the integrity thereof.

It is another object of the invention to provide an optical attenuator of a minimized size and a high integrity so that the productivity of the optical fiber can be improved.

According to an aspect of the invention, it is provided a multi-channel variable optical attenuator comprising: at least two optical signal transmission lines arranged parallel with each other, and having associated separating spaces formed between input and output terminals to adjust the power of an optical signal; a screen placed in one of the separating spaces of the optical signal transmission lines, and being movable in a direction crossing the optical signal transmission lines; and a Micro Electro Mechanical System (MEMS) actuator placed above one of the optical signal transmission lines, and connected with the screen to shift the same, wherein the MEMS actuator is placed above a first optical signal transmission line which is placed adjacent to a second optical signal transmission line for placing the screen therein.

It is preferred that each of the optical signal transmission lines comprises an optical fiber.

It is preferred that the separating spaces of the first and second optical signal transmission lines are arranged on different lines or the same line. Where the separating spaces of the first and second optical signal transmission lines are arranged on the same line, the screen placed in the separating space is shaped to have a concave step at an upper end to avoid interference with other driving units.

It is also preferred that the MEMS actuator comprises a comb actuator, and the screen is initially positioned to block light which propagates through the separating space, and pulled toward a driving unit when the driving unit is operated.

According to another aspect of the invention, it is provided a method for fabricating a multi-channel variable optical attenuator, the method comprising the following steps of:
preparing a Silicon-On Insulator (SOI) wafer having lower and upper Si layers and an oxide layer formed between the lower and upper Si layers;
etching the upper Si layer and the oxide layer of the SOI wafer to form structures for receiving at least two optical signal transmission lines;
preparing a Si wafer having a Si layer;
etching the Si wafer to form a screen on the Si wafer;
bonding the Si wafer on the SOI wafer so that the screen of the Si wafer is placed between the structures of the SOI wafer;
etching the Si wafer to form MEMS actuators in the Si wafer; and
inserting optical signal transmission lines between the structures of the SOI wafer.

It is preferred that each of the optical signal transmission lines comprises an optical fiber, and the screen is formed on a line different from or same as that of an adjacent screen.

It is also preferred that the screen placed is shaped to have a concave step at an upper end to avoid interference with other driving units, and the MEMS actuator comprises a comb actuator.

According to further another aspect of the invention, it is provided a multi-channel variable optical attenuator comprising: optical fibers forming at least two optical signal transmission lines arranged parallel with each other, the optical signal transmission lines having associated separating spaces formed on different lines between input and output terminals to adjust the power of an optical signal; a screen placed in one of the separating spaces of the optical signal transmission lines to attenuate the optical signal, and being movable in a direction crossing the optical signal transmission lines; a comb-type Micro Electro Mechanical System (MEMS) actuator placed above one of the optical signal transmission lines, and connected with the screen to shift the same, wherein the MEMS actuator is placed above a first optical signal transmission line which is placed adjacent to a second optical signal transmission line for placing the screen therein; and terminals connected with the comb-type MEMS actuator to apply electric current to the same.

It is preferred that the screen is initially positioned to block light which propagates through the separating space, and pulled toward a driving unit when the driving unit is operated.

According to still another aspect of the invention, it is provided a multi-channel variable optical attenuator comprising: optical fibers forming at least two optical signal transmission lines arranged parallel with each other, the optical signal transmission lines having associated separating spaces formed on a same line between input and output terminals to adjust the power of an optical signal; a screen placed in one of the separating spaces of the optical signal transmission lines to attenuate the optical signal, being movable in a direction crossing the optical signal transmission lines, and being shaped to have a concave step at an upper end to avoid interference with other driving units; a comb-type Micro Electro Mechanical System (MEMS) actuator placed above one of the optical signal transmission lines, and connected with the screen to shift the same, wherein the MEMS actuator is placed above a first optical signal transmission line which is placed adjacent to a second optical signal transmission line for placing the screen therein; and terminals connected with the comb-type MEMS actuator to apply electric current to the same.

It is preferred that the screen is initially positioned to block light which propagates through the separating space, and pulled toward a driving unit when the driving unit is operated.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates a single channel VOA of the prior art;

FIG. 2 is a sectional view taken along a line A-A′ in FIG. 1;

FIG. 3 illustrates a multi-channel VOA of the prior art;

FIG. 4 illustrates a multi-channel VOA in accordance with the invention;

FIG. 5 is a sectional view taken along a line B-B′ in FIG. 4;

FIG. 6 is a sectional view taken along a line C-C′ in FIG. 4;

FIG. 7 illustrates an alternative to the multi-channel VOA in accordance with the invention;

FIG. 8 is a sectional view taken along a line D-D′ in FIG. 7;

FIG. 9 illustrates another alternative to the multi-channel VOA in accordance with the invention;

FIG. 10 is a sectional view taken along a line E-E′ in FIG. 9; and

FIGS. 11A through 11J are sectional views illustrating a fabrication process of the multi-channel VOA in accordance with the invention.

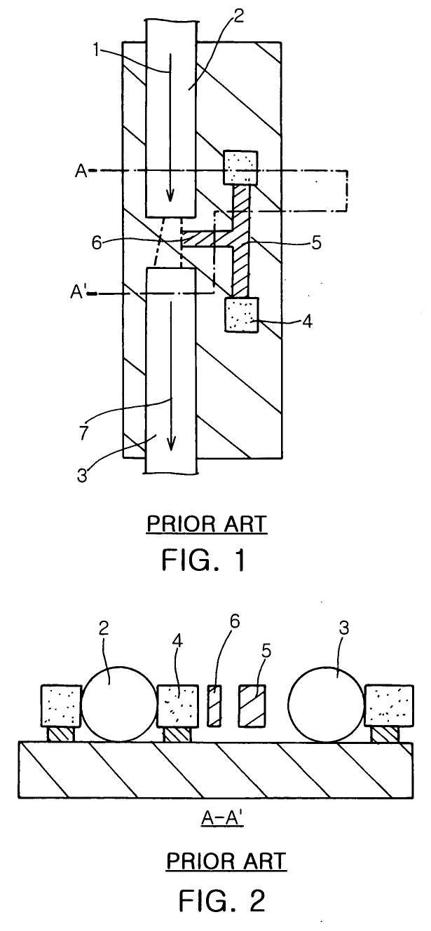

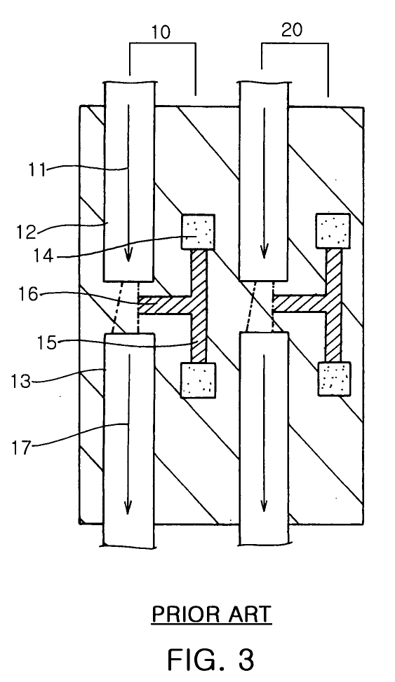

### DETAILED DESCRIPTION OF THE PREFERRED EMBODIMENT

Hereinafter, preferred embodiments of the present invention will be described in detail with reference to the attached drawings.

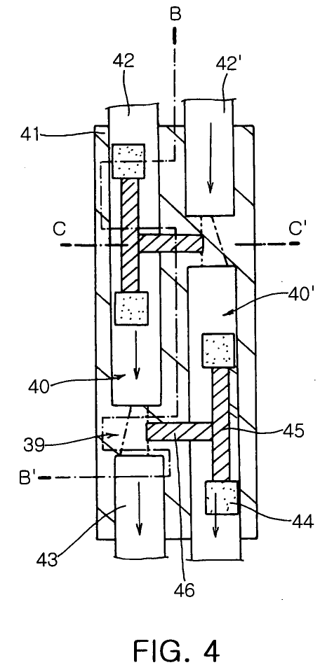

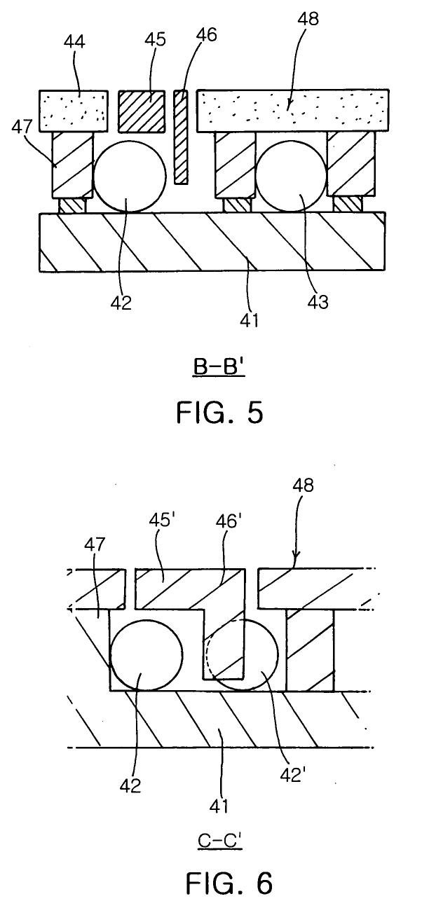

FIG. 4 illustrates a multi-channel VOA in accordance with the invention, and FIG. 5 is a sectional view taken along a line B-B′ in FIG. 4.

According to an aspect of the multi-channel VOA of the invention, actuators for driving screens are placed on a plane different from that of the screens, which are installed movably and alternately in separating spaces defined between optical signal input and output terminals, thereby to enhance the integrity of the multi-channel VOA.

Referring to FIG. 4, there is provided an optical signal transmission line 40 having an input terminal 42 and an output terminal 43 for optical signals. The optical signal transmission line 40 also has a separating space 39 of a predetermined length between the input terminals 42 and the output terminal 43. The separating space 39 functions to attenuate the power of an optical signal to a suitable level and output the attenuated optical signal.

The multi-channel VOA of the invention comprises an array of at least two optical signal transmission lines 40 and 40′ including the afore-described optical signal transmission line 40. This array is provided for the purpose of realizing multi-channels in the VOA. It is preferred that the optical signal transmission lines 40 and 40′ are arranged parallel with each other to improve integrity. Although the array has the two optical signal transmission lines 40 and 40′ in FIG. 4, this is shown for illustrative purposes only, but the invention is not limited to this arrangement.

The optical signal transmission line 40 preferably comprises an optical fiber. Even though the optical fiber may be made of synthetic resin, it is generally made of glass of excellent transparency. The optical fiber has a dual cylinder configuration of an outer cladding and a central core wrapped in the cladding. The optical fiber is coated with a synthetic resin sheath for protecting the optical fiber from impact. In the optical fiber, the core has an index of refraction higher than that of the cladding so that optical signals are concentrated in the core to propagate along the optical fiber without loss.

In the separating space 39 of the optical signal transmission line 40, there is provided a screen 46 that is movable in a direction crossing the optical signal transmission line 40. The screen 46 is so placed to block the core of the optical fiber, and has a configuration as shown in FIGS. 5 and 6. The screen 46 has a free end for attenuating the power of the optical signal through contact therewith and an opposite stationary end connected with an actuator 45 functioning to drive the screen 46.

In the present invention, available examples of the actuator 45 for driving the screen 46 may include a Micro ElectroMechanical System (MEMS) actuator. The MEMS actuator is provided as a microscopic driving means which includes a driving mechanism formed on a silicon wafer through etching, and performs microscopic actuation upon application of electric current. The screen 46 is typically formed integral with the MEMS actuator.

The MEMS actuator 45 is placed above the optical signal transmission line 40′ which is arranged adjacent to the optical signal transmission line 40 where the screen 46 is placed. A conventional multi-channel VOA requires additional spaces for placing driving units between transmission lines since the driving units are arranged coplanar with the optical signal transmission lines. As a result, conventional structures can hardly enhance the integrity of the multi-channel VOA up to a desired level.

However, the invention places the MEMS actuators functioning as the driving units above the adjacent transmission lines so that the driving units and the optical signal transmission lines are placed on different planes so as to remove the additional spaces between the optical signal transmission lines occupied by the driving units, thereby enhancing the integrity of the VOA.

In FIG. 4, the screen 46 is placed in the separating space 39 of the optical signal transmission line 40 crossing the optical signal transmission line 40, and connected with the MEMS actuator 45 which is placed above the adjacent optical signal transmission line 40′. Although the screen 46 is arranged movable in a direction crossing the optical signal transmission line 40 in this embodiment, the screen 46 may be designed movable along an inclination rather than perpendicularly.

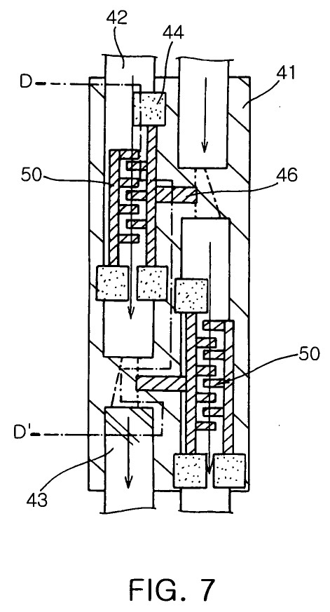

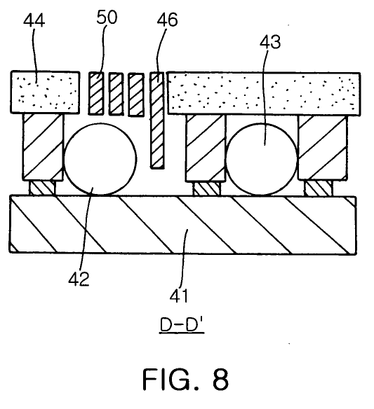

The MEMS actuator 45 is provided with terminals 44 at both ends thereof so that electric current is applied to the MEMS actuator 45 through the terminals 44 to energize the same. The MEMS actuator is preferably a comb actuator, which is specifically illustrated in FIGS. 7 and 8.

Referring to FIG. 5, the optical fibers 42 and 43 of the optical signal transmission line 40 are arranged on an underlying substrate 41, interposed between a side structure 47 on the substrate 41 and an upper structure 48 forming the driving means. For reference, FIG. 5 is a sectional view taken along a line B-B′ in FIG. 4. The upper structure 48 placed above the optical fibers 42 and 43 of the optical signal transmission line 40 comprises the MEMS actuator 45, the screen 46 and the terminals 44.

Referring to FIG. 4 again, the separating spaces 39 of the optical signal transmission line 40 and 40′ are placed on lines which are not coincidental with each other. That is, the separating spaces are arranged on different imaginary lines drawn perpendicular to the optical signal transmission lines. As a result, this allows the MEMS actuators placed above the optical signal transmission lines to alternate with each other. As shown in FIG. 4, a pair of the MEMS actuators are arranged opposite with each other.

FIG. 6 is a sectional view taken along a line C-C′ in FIG. 4, which illustrates the arrangement of a screen 46′ of an MEMS actuator 45′, in which the screen 46′ is integrally connected with the actuator 45′. The optical fiber 42 is placed between the substrate 41 and the upper structure 48, and an optical fiber 42′ is also placed between the substrate 41 and the upper structure 48. While the optical fiber 42 forms the afore-described optical signal transmission line 40, the optical fiber 42′ forms the optical signal transmission line 40′ adjacent to the optical signal transmission line 40.

The screen 46′ shown in FIG. 6 functions to attenuate the power of an optical signal transmitted along the optical signal transmission line 40′ in FIG. 4, and is placed to cover a core of the optical fiber 42′. The screen 46′ is extended horizontal above the optical fiber 42 and then extended downward to define a bent configuration. An upper end of the screen 46′ is integrated into the MEMS actuator 45, which in turn is connected with terminals formed in the upper structure 48.

FIG. 7 illustrates an alternative to the multi-channel VOA in accordance with the invention, in which separating spaces of the above structure are formed to alternate with each other, and FIG. 8 is a sectional view taken along a line D-D′ in FIG. 7. As shown in FIGS. 7 and 8, the MEMS actuator of the VOA in accordance with the invention preferably utilizes a comb actuator. The comb actuator 50 includes a first member having a plurality of first horizontal combs and a second member opposed to the first horizontal combs and having a plurality of second horizontal combs, in which the second horizontal combs are opposed to the first horizontal combs while alternating with the same. Application of electric current to the first and second members generates attractive force between the first and second members based upon voltage difference, thereby shifting the screen 46 which is connected with the first or second member.

The screen 46 has an initial position to hide cores of optical fibers 42 and 43, and is preferably driven by the actuator 50 to expose the cores according to operative characteristics of the comb actuator 50 functioning as a driving means. Alternatively, the screen may be operated otherwise with a different type MEMS actuator.

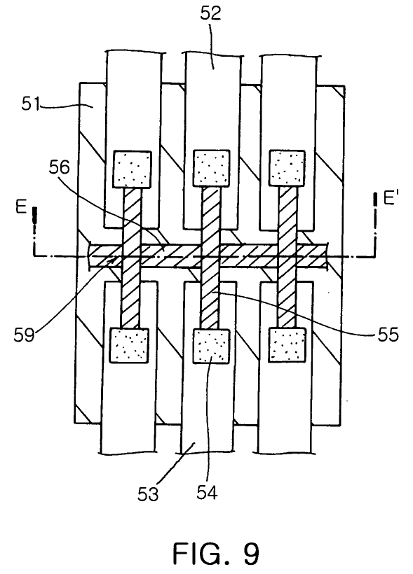

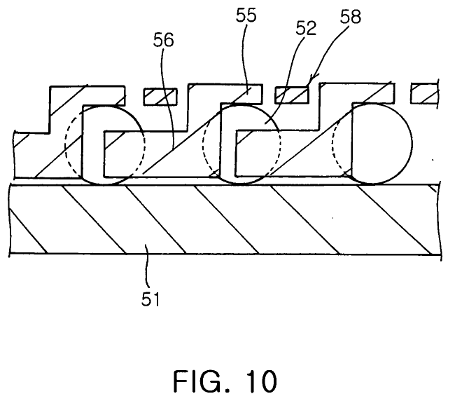

FIG. 9 illustrates another alternative to the multi-channel VOA in accordance with the invention, and FIG. 10 is a sectional view taken along a line E-E′ in FIG. 9.

In the multi-channel VOA of the invention, separating spaces 59 between optical signal transmission lines 52 and 53 can be formed on a same horizontal line. If the separating spaces 59 are formed on the same horizontal line as shown in FIG. 9, screens 56 for adjusting the power of an optical signal have a configuration different from those of the foregoing embodiments shown in FIGS. 4 and 7.

That is, where the separating spaces are formed on the same line, actuators 55 and the screens 56 connected with the actuators 55 are arranged on a same line. Then, the screens 56 are preferably provided with concave steps in upper portions thereof in order to prevent interference between adjacent screens 56. The cross sectional shape of such screens 56 are shown in FIG. 10. Also in this embodiment shown in FIG. 9, terminals 54 connected with each actuator 55 are formed in an upper structure 58 as in the afore-described embodiments.

If the actuator is placed above the optical signal transmission line, the VOA of the present invention provides an advantage of enhancing the integrity of the optical signal transmission line. In the prior art, separate electric signals are necessarily applied to the respective channels since the driving actuators are placed to alternate with the optical signal transmission lines. However, according to the present invention, the actuators and the terminals for applying electric current to the actuators are placed above the optical fibers to advantageously raise the design flexibility of the terminals of the channels and the patterns connected to the terminals.

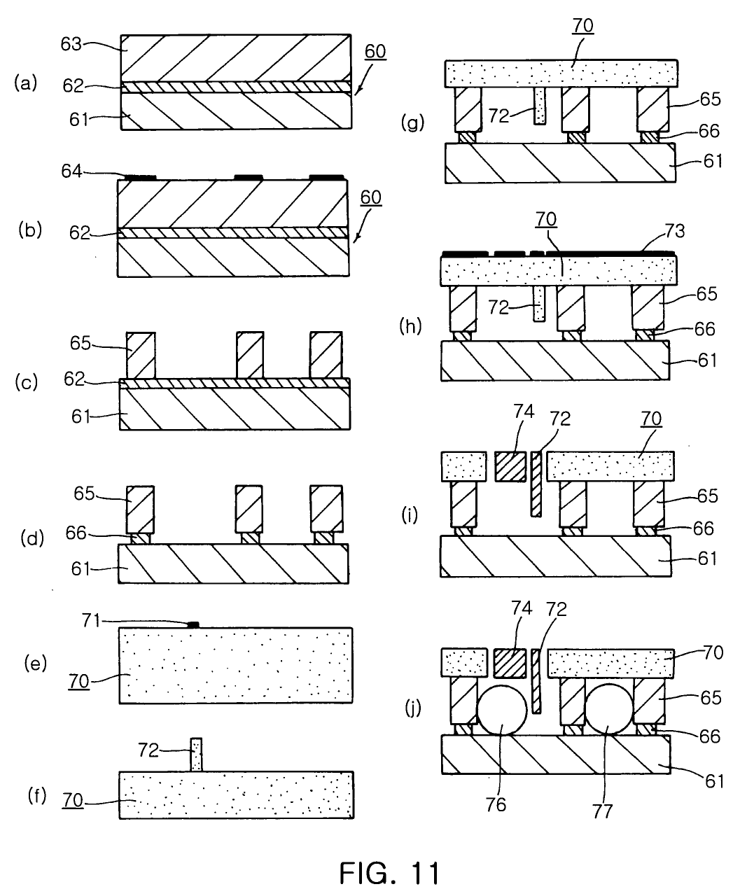

FIGS. 11A through 11J are sectional views taken along the line B-B′ in FIG. 4 to illustrate a fabrication process of the multi-channel VOA in accordance with the invention.

First, a SiO₂ wafer or Silicon-On Insulator (SOI) wafer 60, which comprises a lower Si layer 61 made of Si as a lower structure of the SOI wafer 60, an oxide layer 62 made of SiO₂ overlying the lower Si layer 61 and an upper Si layer 63 made of Si overlying the oxide layer 62, is prepared. (Refer to FIG. 11A.)

An etching pattern 64 is formed on the upper Si layer 63 of the SOI wafer 60, and then the upper Si layer 63 is selectively etched using the etching pattern 64 as a mask to form side structures 65. (Refer to FIGS. 11B and 11C.) The oxide layer 62 of the SOI wafer 60 is etched to expose the lower Si layer 61 under the side structures 65 so that the lower Si layer 61 functions as a substrate. (Refer to FIG. 11D.) A wafer 70 made of Si is prepared, and an etching patter 71 is formed on a top surface of the Si wafer 70. (Refer to FIG. 11E). The wafer 70 is etched to a predetermined depth using the etching pattern 71 as a mask to form a screen 72. (Refer to FIG. 11F.) The screen 72 is extended beyond the upper structure 48 according to the embodiments which are previously described with reference to FIGS. 4, 7 and 9. It is understood that these process steps form a structure for the screen in the Si wafer 70.

The Si wafer 70 having the screen 72 formed as above is overturned and seated on the SOI wafer 60 so that the screen 72 is placed between the side structures 65 above an optical signal transmission line. Then, the Si wafer 70 and the SOI wafer are bonded together, and the Si wafer 70 is polished to a predetermined thickness. (Refer to FIG. 11G.)

An etching pattern 73 is formed on the Si wafer 70 functioning as an upper layer of an optical attenuator. (Refer to FIG. 11H.) Then, the etching pattern 73 is etched using the etching pattern 73 as a mask to form an actuator 74 and complete the screen 72. (Refer to FIG. 11I.) In the above steps, terminals for applying electric current to the actuator and other patterns are also formed.

As a final step, optical fibers 76 and 77 are inserted between the side structures 65 of the SOI wafer 60 between the SOI wafer 60 and the Si wafer 70. (Refer to FIG. 11J.) Then, the optical fiber 76 forms an input terminal, and the optical fiber 77 forms an output terminal. The optical fibers 76 and 77 are inserted to a point adjacent to the screen 72 which blocks the optical fibers 76 and 77 from each other.

In this case, the screen 72 may be placed on a line same as that of other screens in other transmission lines (i.e., the embodiment shown in FIG. 9). Alternatively, the screens including the screen 72 may be placed on different lines (i.e., the embodiment shown in FIGS. 4 and 7). Where the screens are placed on the same line, the screens are preferably shaped to have concave steps in upper portions thereof. (Refer to FIG. 10). This shape can be achieved by adjusting the pattern and quantity of etching in the foregoing steps in FIGS. 11H and 11I. Also, the actuator is preferably a comb actuator.

As set forth above, the present invention separates a fiber optic module from an attenuating module so that the fiber optical module and the attenuating module are placed on different planes in order to reduce the overall size of the optical attenuator while enhancing the integrity thereof. In particular, the optical attenuator of the invention has a compact design to arrange the optical signal transmission lines close to one another, thereby forming more channels in the same-sized optical attenuator.

Since the actuators are arranged above the transmission lines, the multi-channel VOA of the invention has a high flexibility in signaling the respective driving means as well as forming the patterns.

As described above, the optical attenuator of the present invention enhances integrity by minimizing the area for arranging the optical fibers. Thus, although the optical attenuator and the wafer have same sizes as the conventional ones, the multi-channel optical attenuator of the invention formed in the same-sized wafer can have more channels. Furthermore, when optical attenuators having same number of channels are fabricated from the same wafer, the present invention can yield more optical attenuators than the prior art, thereby to improve the productivity of a fabrication process of optical attenuators.

Although the preferred embodiment of the present invention has been disclosed for illustrative purposes, those skilled in the art will appreciate that various modifications, additions and substitutions can be made without departing from the scope and spirit of the invention as disclosed in the accompanying claims.

1. A multi-channel variable optical attenuator comprising:
at least two optical signal transmission lines arranged parallel with each other, and having associated separating spaces formed between input and output terminals to adjust the power of an optical signal;
a screen placed in one of the separating spaces of the optical signal transmission lines, and being movable in a direction crossing the optical signal transmission lines; and
a Micro Electro Mechanical System (MEMS) actuator placed above one of the optical signal transmission lines, and connected with the screen to shift the same, wherein the MEMS actuator is placed above a first optical signal transmission line which is placed adjacent to a second optical signal transmission line for placing the screen therein.

2. The multi-channel variable optical attenuator as set forth in claim 1, wherein each of the optical signal transmission lines comprises an optical fiber.

3. The multi-channel variable optical attenuator as set forth in claim 1, wherein the separating spaces of the first and second optical signal transmission lines are arranged on different lines.

4. The multi-channel variable optical attenuator as set forth in claim 1, wherein the separating spaces of the first and second optical signal transmission lines are arranged on the same line.

5. The multi-channel variable optical attenuator as set forth in claim 4, wherein the screen placed in the separating space is shaped to have a concave step at an upper end to avoid interference with other driving units.

6. The multi-channel variable optical attenuator as set forth in claim 1, wherein the MEMS actuator comprises a comb actuator.

7. The multi-channel variable optical attenuator as set forth in claim 1, wherein the screen is initially positioned to block light which propagates through the separating space, and pulled toward a driving unit when the driving unit is operated.

8. A method for fabricating a multi-channel variable optical attenuator, the method comprising the following steps of:
preparing a Silicon-On Insulator (SOI) wafer having lower and upper Si layers and an oxide layer formed between the lower and upper Si layers;
etching the upper Si layer and the oxide layer of the SOI wafer to form structures for receiving at least two optical signal transmission lines;
preparing a Si wafer having a Si layer;
etching the Si wafer to form a screen on the Si wafer;
bonding the Si wafer on the SOI wafer so that the screen of the Si wafer is placed between the structures of the SOI wafer;
etching the Si wafer to form MEMS actuators in the Si wafer; and
inserting optical signal transmission lines between the structures of the SOI wafer.

9. The method for fabricating a multi-channel variable optical attenuator as set forth in claim 8, wherein each of the optical signal transmission lines comprises an optical fiber.

10. The method for fabricating a multi-channel variable optical attenuator as set forth in claim 9, wherein the screen is formed on a line different from that of an adjacent screen.

11. The method for fabricating a multi-channel variable optical attenuator as set forth in claim 9, wherein the screen is formed on a line same as that of an adjacent screen.

12. The method for fabricating a multi-channel variable optical attenuator as set forth in claim 11, the screen placed is shaped to have a concave step at an upper end to avoid interference with other driving units.

13. The method for fabricating a multi-channel variable optical attenuator as set forth in claim 8, wherein the MEMS actuator comprises a comb actuator.

14. A multi-channel variable optical attenuator comprising:
optical fibers forming at least two optical signal transmission lines arranged parallel with each other, the optical signal transmission lines having associated separating spaces formed on different lines between input and output terminals to adjust the power of an optical signal;
a screen placed in one of the separating spaces of the optical signal transmission lines to attenuate the optical signal, and being movable in a direction crossing the optical signal transmission lines;
a comb-type Micro ElectroMechanical System (MEMS) actuator placed above one of the optical signal transmission lines, and connected with the screen to shift the same, wherein the MEMS actuator is placed above a first optical signal transmission line which is placed adjacent to a second optical signal transmission line for placing the screen therein; and
terminals connected with the comb-type MEMS actuator to apply electric current to the same.

15. The multi-channel variable optical attenuator as set forth in claim 14, wherein the screen is initially positioned to block light which propagates through the separating space, and pulled toward a driving unit when the driving unit is operated.

16. A multi-channel variable optical attenuator comprising:
optical fibers forming at least two optical signal transmission lines arranged parallel with each other, the optical signal transmission lines having associated separating spaces formed on a same line between input and output terminals to adjust the power of an optical signal;
a screen placed in one of the separating spaces of the optical signal transmission lines to attenuate the optical signal, being movable in a direction crossing the optical signal transmission lines, and being shaped to have a concave step at an upper end to avoid interference with other driving units;
a comb-type Micro ElectroMechanical System (MEMS) actuator placed above one of the optical signal transmission lines, and connected with the screen to shift the same, wherein the MEMS actuator is placed above a first optical signal transmission line which is placed adjacent to a second optical signal transmission line for placing the screen therein; and
terminals connected with the comb-type MEMS actuator to apply electric current to the same.

17. The multi-channel variable optical attenuator as set forth in claim 16, wherein the screen is initially positioned to block light which propagates through the separating space, and pulled toward a driving unit when the driving unit is operated.
